(19) United States
(12) Patent Application Publication
(10) Pub. No.: US 2014/0029395 A1
(43) Pub. Date: Jan. 30, 2014

(54) Method and System for Recording Audio

(71) Applicants: Michael Nicholas Bolas, New York, NY (US); Darrell Royce Brown, Encino, CA (US)

(72) Inventors: Michael Nicholas Bolas, New York, NY (US); Darrell Royce Brown, Encino, CA (US)

(21) Appl. No.: 13/560,819

(22) Filed: Jul. 27, 2012

(51) Int. Cl. G09B 5/04

(52) U.S. Cl. 369/4; G9B/15.006

(57) ABSTRACT

An audio recording software program adapted to capture spontaneous extemporaneous performance after group recording. The software permits a user to suspend recording of some tracks while continuing recording of at least one track, to capture extemporaneous performances of musical phrases, especially vocal performances, which are often preferred in the extemporaneous utterance which are difficult to recapture.

### FIELD OF THE INVENTIONS

The inventions described below relate the field of audio recording.

### BACKGROUND OF THE INVENTIONS

Audio recording of ensemble performances is accomplished with the help of computers and audio recording, editing and mixing software. Producers operate microphones, computers and massive computer storage media (and sometimes analog recording media) to record and store performances on various tracks associated with individual performers, subgroups within an ensemble, or particular instruments. Various software programs, including Pro Tool, Logic, and even GarageBand, may be used for recording ensemble performances into various tracks, editing these tracks, and mixing tracks into one stereo channels or multiple channels. These programs are referred to as digital audio workstations or digital audio editors.

A recording session may entail numerous takes, which may comprise complete or partial performances of a song or musical movement or musical passage. Numerous takes are obtained in an effort to capture variations in the performance, which can be reviewed after a recording session in an editing session. In an editing session, the producer may operate the digital audio workstation software to piece together a finished song by moving clips from various takes, and tracks within takes, into a finished piece.

During the course of a recording session, a producer may interrupt a performance to give direction to the performers. During these breaks, the producer will suspend recording. After providing directions, the producer will direct the musicians to restart or continue the performance, and restart recording the various musicians. Because digital storage space is limited, and many audio tracks consume large amounts of storage space, leaving the tracks in recording mode is not feasible. Often, an experimental or practice performance of a musical passage during a break between takes is considered ideal by the performer and producer, but is difficult to recreate in a subsequent take in which the entire ensemble is recorded together.

### SUMMARY

The methods and devices described below provide for an audio recording method, system, and associated software program adapted to capture spontaneous extemporaneous performance of a single performer after group recording of an ensemble has been suspended after a take. The software permits a user to suspend recording of some tracks while continuing recording of at least one track, to capture extemporaneous performances of musical phrases, especially in vocal performances, associated with but separate from the main track. These extemporaneous performances are often preferred to accompanied performances, but are often difficult to recapture in a take with the entire ensemble in accompaniment. The extemporaneous performance is stored in files separate from the clip files used to store audio associated with tracks and playlists. The extemporaneous performance clips are catalogued by time of day, for easy recall, and the title of each extemporaneous clip may be altered to help the producer recall it during editing. For convenience, we will refer to this new track as an extemporaneous performance track, and we will refer to clips extracted from the extemporaneous performance track as an extemporaneous performance clip.

Afterward, during an editing session, the producer can cut and paste passages from the extemporaneous performance clips, which were produced in isolation from the ensemble performance, into the tracks obtained during the ensemble performance, to create a final version of a song.

### BRIEF DESCRIPTION OF THE DRAWINGS

FIG. 1 illustrates an arrange window for an audio project in an audio recording software program illustrating the basic layout of an arrange window.

FIG. 2 illustrates an arrange window for an audio project in an audio recording software program illustrating the screen elements used to enable the extemporaneous performance track capture feature for a single track.

FIG. 3 illustrates an arrange window for an audio project in an audio recording software program illustrating the screen elements used to communicate that the extemporaneous performance track capture feature has been enabled for a single track.

FIG. 4 illustrates an arrange window for an audio project in an audio recording software program illustrating the screen elements used to communicate that the extemporaneous performance track capture feature is operating to capture audio data from the input associated with the vocal track.

FIG. 5 illustrates an arrange window for an audio project in an audio recording software program illustrating the selection of a clip from the extemporaneous performance clip into the track associated with the extemporaneous performance track capture feature.

### DETAILED DESCRIPTION OF THE INVENTIONS

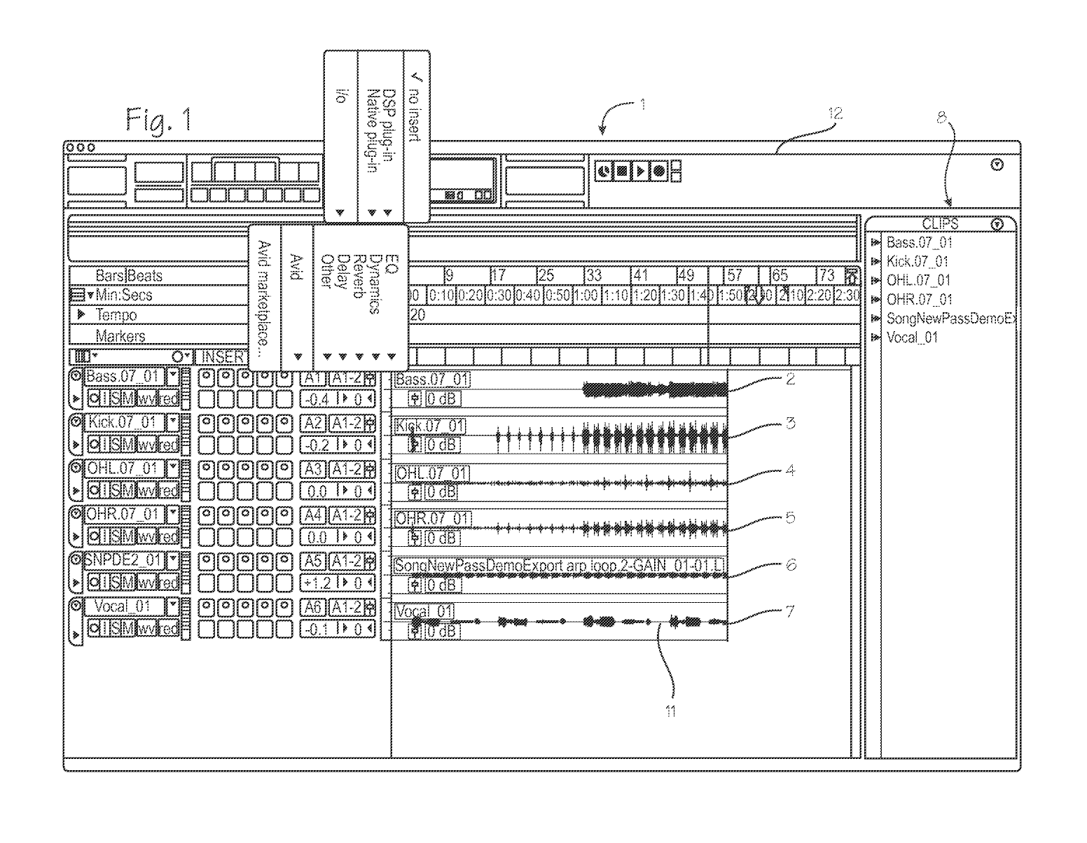

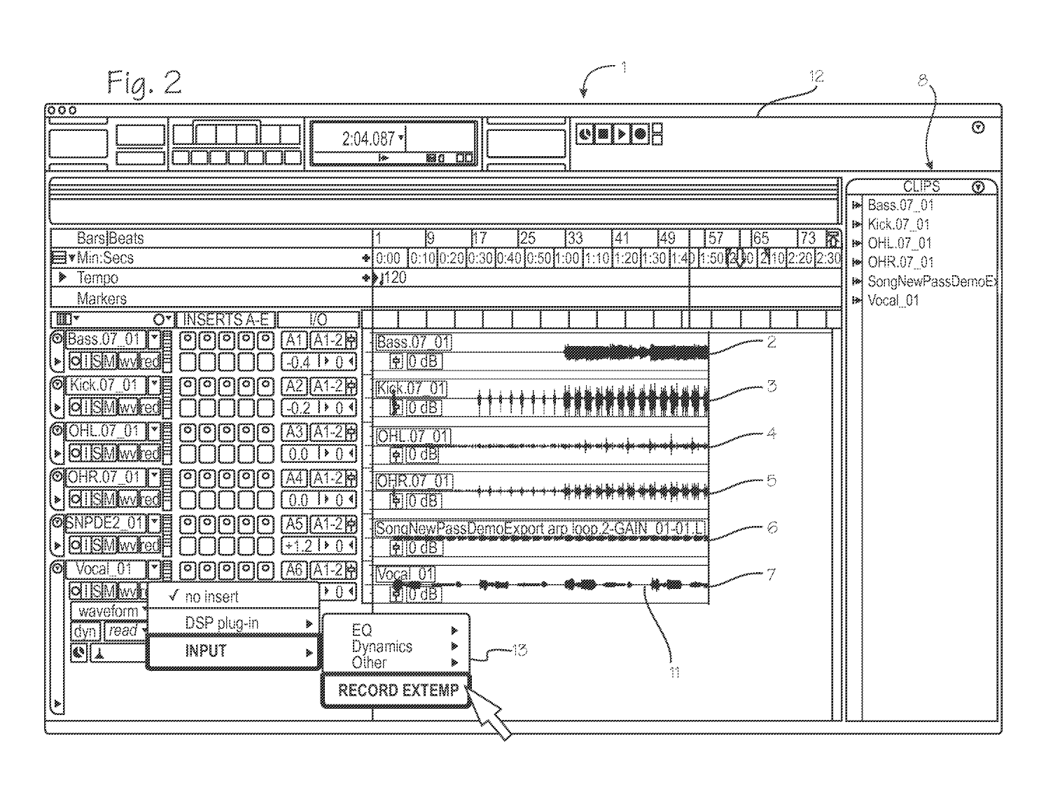

FIGS. 1 and 2 illustrate an recording window 1 of a typical recording/arranging software, or digital audio workstation program, used in the recording industry. The window includes one or more recording tracks, which may correspond to audio recorded from different instruments and singers performing a song while being recorded. In this simplified example, the system is recording several tracks: one instrumental track 2 for recording a bass guitar being played by a guitarist, several tracks 3, 4 and 5 for percussion, track 6 for loops inserted from computer files, and a vocal track 7 for recording the voice of a singer. The software may provide for any number of additional tracks. The producer controls the software, in conjunction with microphones and storage media and computers to record the various performers, including the instrumentalists and the singer, on the separate tracks. (The performers may be acoustically isolated from each other so that the files will be distinct, and no vocals will be recorded on the instrumental tracks, and no instrument will be recorded on the vocal track, or they may be acoustically mixed so that each track, while predominantly recording the performer associated with track, also picks up audio from other performers.) The “tracks” are files stored on the storage media, and are analogous to physical separate recording tracks previously used in the recording process. The files are stored as one or more clips, in a folder stored on the storage media. The clips are catalogued and listed in the clips sidebar window 8. Each track may comprise a single clip or multiple clips, and the clips may be of any length.

Each track is represented in the recording window by a waveform, such as wave form 11, which provides a representation of the volume of the performer. The waveform is presented in scrolling fashion, starting from the left of the track window and building to the right. FIG. 2 illustrates the arrange window of FIG. 1, with the additional representation of a control window 12 and an additional representation of an interface element for controlling use of the additional recording process of the new method. The control window provides a user interface through which the producer can initiate recording of the performers, stop recording, and replay the recorded tracks. An interface element 13, represented here as a pulldown window, is operable by the user to activate the extemporaneous performance track capture feature by pulling down through the pulldown windows until the feature name is visible (in this case, the name is “RECORD EXTEMP”), and selecting the feature name by clicking on the pull down item in which the name of the feature appears.

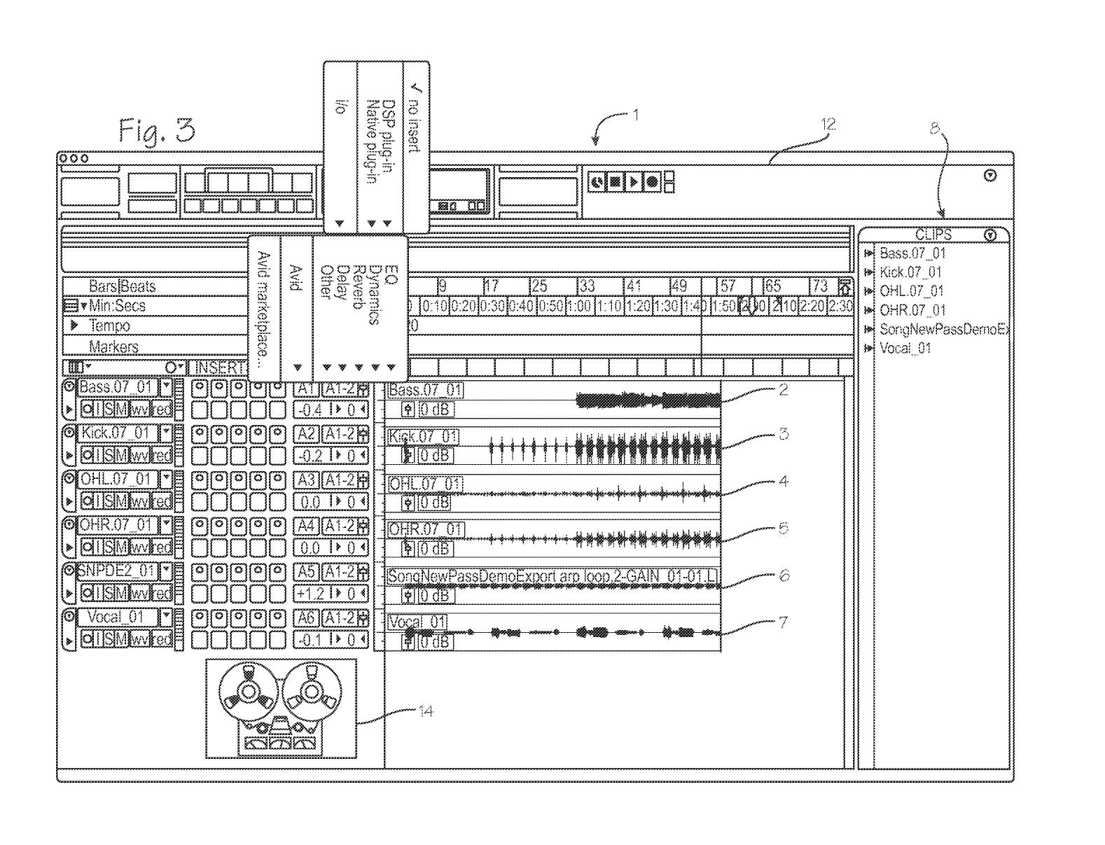

FIG. 3 illustrates the arrange window of FIG. 1, with a new “activation status” interface element 14 displayed in association with the track for which the scratch feature has been activated. In this illustration, the activation is communicated by the presentation of the image of a reel-to-reel tape deck. Any other design may be used for activation status interface element, and its function may be intuitively understood from the design or communicated to the user through a user manual or pop-up tool tip in the interface, or a status bar in the user interface.

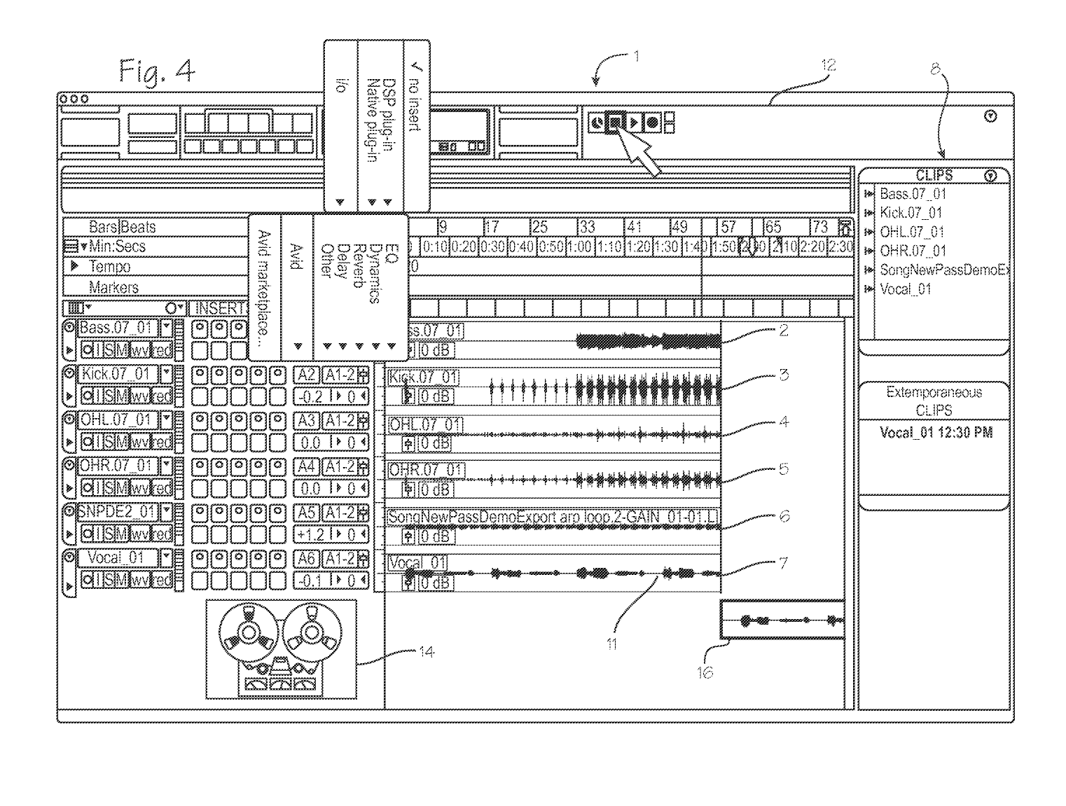

When the extemporaneous performance track capture feature is activated, as illustrated in FIG. 3, the software operates in conjunction with the computer and inputs in communication with the computer to record and store audio received through the microphone (or other input). As illustrated in FIG. 4, when the producer ends recording of a take (by selecting the stop button in the control window 12), the computer will stop recording on all the tracks. For the track for which the extemporaneous performance track capture feature has been activated, the software will operate in conjunction with the computer to initiate recording input from a microphone to a separate file (not the file associated with the track), which may be in a separate folder in the storage media, or on a separate storage media altogether (such as a separate hard drive or flash drive). In a new “extemporaneous clips” sidebar window 15, the software displays the file as a clip, entitled with the time of day when it is recorded. During the break between takes, the producer may work with the vocalist associated with the track and the extemporaneous performance track file, giving direction for the vocalist to modify his performance, or the vocalist may experiment on his own, varying any number of parameters to achieve an aesthetically optimum result. Experimental or practice performances during this break will be recorded in the extemporaneous track 16. When the producer wants to return to recording the entire ensemble, he can initiate recording on all the tracks by selecting the start screen interface element. The computer will then operate to re-initiate recording and storage from the various tracks, and suspend recording on the extemporaneous track.

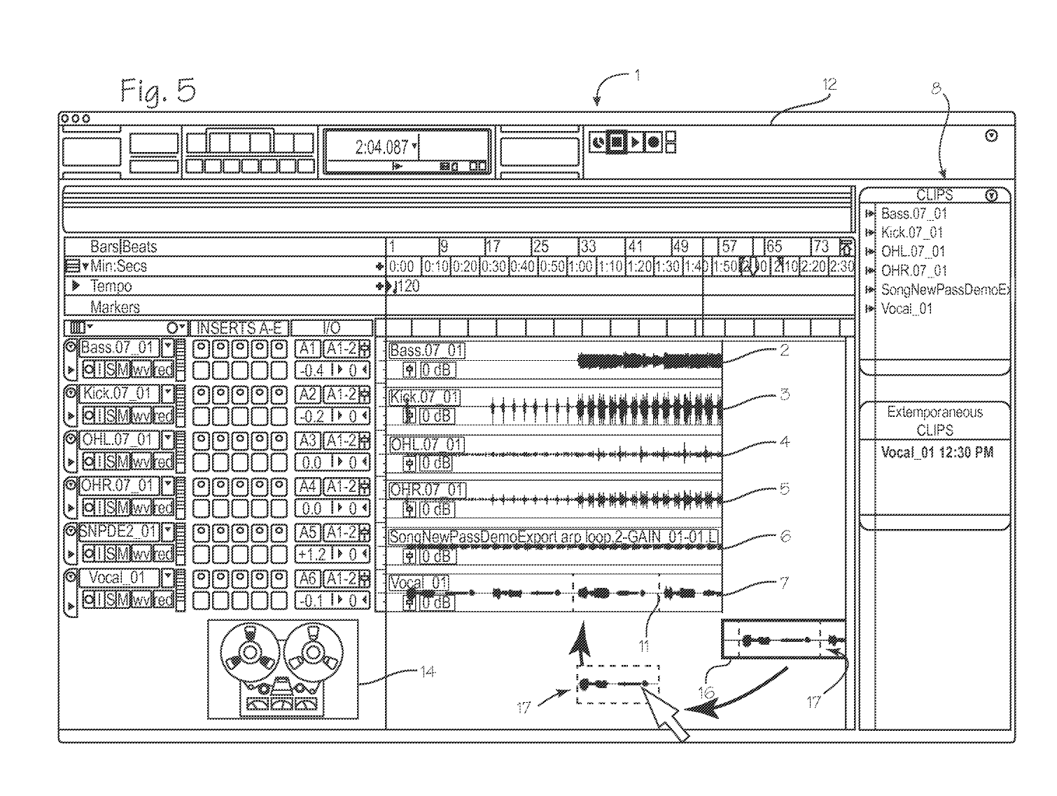

As illustrated in FIG. 5, the software can be used to mix audio tracks, using segments or passages from the extemporaneous performance track or clips by selecting the segment, copying the segment, for example, and moving it to the vocal track and arranging it time-wise in relation to the track. FIG. 5 may be referred to as an edit window, and may present various user interface elements useful for various editing functions. It may be presented in a window distinct from the arrange window, or presented in the same window. A screen element depicting a preferred segment 17 of performance can be selected from an extemporaneous performance clip, copied from the extemporaneous performance clip, and inserted into the associated track, using the typically pre-existing user interface elements of the audio recording software. This is illustrated by the use of the cursor in FIG. 5 to select and drag the screen element 17 from its original place in the extemporaneous performance track into a position in the vocal track 7, at a position indicated by the dashed lines. (By comparison of the extemporaneous waveform with the ensemble waveform in the vocal track, the extemporaneous performance is slightly different that performance during the ensemble recording.) The corresponding preferred segment will replace the original segment in the vocal track. The software allows such substitution with a degree of precision such that the transition between the different clips and segments is imperceptible. After editing, the audio files representing the finished version of the ensemble performance is saved, exported, mixed and stored on media for distribution.

As described above, the method of recording and mixing a performance of an ensemble of musical performers, when applied to an ensemble comprising several instrumentalists and a singer, comprises the steps of initiating recording of a take of an ensemble performance using a digital audio workstation program operating on a computer, with associated storage media for storing audio data and associated input means such as microphones and pick-ups and direct connections for electronic instruments, recording the singer on a first track, and storing the track in a first file; recording the instrumentalists on one or more additional tracks, and storing the one or more additional tracks in corresponding additional files, suspending recording of the take on occasion, at the discretion of the performers or a producer. After suspending recording of the take, the computer conditionally initiates recording of an extemporaneous performance of the singer in a separate track, and stores the track in a file separate from the first track used to record the singer during the ensemble performance. The term conditionally refers to the need for the need for the producer to activate the extemporaneous recording feature through some user interface element, as it will not always be desirable to activate this feature. It may not be necessary to implement the feature as a selectable feature, in which case the software may be written such that the feature is always active for a vocal track, or is active by default but may be de-selected by the producer. After recording the musical performance and the extemporaneous performance, the producer will work in a mixing session, which entails extensive manipulation of all the audio tracks obtained in the recording sessions. As part of the mixing session, the producer can insert a portion of the extemporaneous performance in the second computer file into the at least one track from the ensemble recordings.

More generally, the method comprises recording a musical performance of the ensemble on at least one track, and storing a digital file corresponding to that track in a first computer file, suspending the musical performance of the ensemble, and thereafter initiating recording of a subset of the ensemble to record extemporaneous performances of the subset to a separate file, and storing said separate file in a second computer file. The subset may be limited to the singer, to the percussionist or percussion section, the bass guitar, a horn section, or any other performer.

The method is implemented in a recording/mixing studio, using audio inputs such as microphones and electronic pickups applied directly to instruments or incorporated into electronic instruments. The audio inputs are connected to a computer and computer storage media through the computer. The computer is programmed to store audio data from various audio inputs in audio “tracks” which are computer files somewhat analogous to the physical tracks associated with analog recording. The computer is also programmed to selectively store audio data from one or more of the audio inputs in computer files separate from the audio tracks, provided that a user has provided some input to the computer to identify the audio track and/or input which is to be used as input to this additional audio data file. The computer is also programmed to catalog that additional audio data file according to the time at which it is created and stored, and present that information in an screen window, such as a sidebar, for recall by one using the system to search and review the audio in the additional audio data file. The computer is further programmed to permit the user to mix segments of the additional audio file into the tracks to create a final version of a musical performance for subsequent distribution.

The function of the extemporaneous performance recording feature can be provided as an integral component of a digital audio workstation or as a plug-in component to an existing digital audio workstation. The software can be stored in computer readable media, and distributed as downloadable files or distributed on computer disks.

The extemporaneous performance recording feature has been illustrated in relation to audio recording and digital audio workstations. The feature may also be implemented in video recording environment, in video recording environments such as movie sets, in which case the extemporaneous performance recording feature can be used to capture audio and video of a performer. In this environment, the input will comprise microphones to capture audio and one or more cameras trained on the performer, and either or both can be recorded in files separate from the main audio tracks and video clips. In editing, an editor can review audio and video in the extemporaneous video and audio clips and select segments of audio and video together, or just audio, or just video, copy these segments, and move them into corresponding tracks.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A method of recording an ensemble of musical performers, said ensemble comprising a plurality of musicians, said method comprising the steps of:
recording musical performance of the ensemble on at least one track, and storing a digital file corresponding to the at least on track in a first computer file;
suspending the musical performance of the ensemble;
after suspending the musical performance of the ensemble, initiating recording of a subset of the ensemble to record extemporaneous performances of the subset to a separate file, and storing said separate file in a second computer file.

2. The method of claim 1 further comprising the steps of:
after recording the musical performance and the extemporaneous performance, inserting a portion of the extemporaneous performance in the second computer file into the at least one track.

3. A method of recording and mixing a performance of an ensemble of musical performers, said ensemble comprising a plurality of instrumentalists and a singer, said method comprising the steps of:
initiating recording of a take of a ensemble performance of the ensemble by:
recording the singer on a first track, and storing the track in a first file;
recording the instrumentalists on one or more additional tracks, and storing the one or more additional tracks in corresponding additional files,
suspending recording of the take;
after suspending recording of the take, initiating recording of an extemporaneous performance of the singer in a separate track, and storing the track in a file separate from the first file;

4. The method of claim 3 further comprising the step of:
after recording the musical performance and the extemporaneous performance, inserting a portion of the extemporaneous performance in the second computer file into the at least one track.

5. A computer readable medium having a program having executable instructions that, when executed by a computer, causes the computer to perform a method for recording audio within a digital audio workstation program comprising the steps of:
receiving audio data from a plurality of audio inputs corresponding to a plurality of musical performers, and storing said audio data corresponding to the plurality of musical performers in a plurality of audio tracks;
receiving input from a user to select an audio input amongst the plurality of audio inputs for recording extemporaneous performance from the selected audio input after suspending the storing of audio data corresponding to the plurality of musical performers in the plurality of audio tracks;
upon receiving input from a user to suspend the storing of audio data corresponding to the plurality of musical performers in the plurality of audio tracks, initiating recording from the selected input and storing recorded audio from the selected input in file separate from the plurality of audio tracks.

6. A computer readable medium having a program having executable instructions that, when executed by a computer, causes the computer to perform a method for recording audio comprising the steps of:
receiving audio data corresponding to;
receiving input from a user to select an input for recording extemporaneous performance from a selected audio input after suspending recording of a plurality of audio tracks from the selected audio input and at least one additional audio input;
upon receiving input from a user to suspend recording of the plurality of audio tracks, initiating recording from the selected input and storing recorded audio from the selected input in file separate any file
